(19) United States
(12) Patent Application Publication
(10) Pub. No.: US 2012/0213687 A1
(43) Pub. Date: Aug. 23, 2012

(54) METHOD FOR MANUFACTURING TRICHLOROSILANE

(75) Inventors: Toshiyuki Ishii, Yokkaichi-shi (JP); Eiji Komai, Yokkaichi-shi (JP); Harumi Satoh, Hitachinaka-shi (JP); Tetsuya Sato, Yokkaichi-shi (JP)

(73) Assignee: MITSUBISHI MATERIALS CORPORATION, Tokyo (JP)

(21) Appl. No.: 13/458,130

(22) Filed: Apr. 27, 2012

Related U.S. Application Data
(63) Continuation-in-part of application No. 12/461,147, filed on Aug. 3, 2009, now Pat. No. 8,187,551.

(30) Foreign Application Priority Data
Aug. 5, 2008 (JP) 2008-201864

(51) Int. Cl. C01B 33/107

(52) U.S. Cl. 423/342

(57) ABSTRACT

A method for manufacturing trichlorosilane in which hydrogen chloride and polymers including high-boiling chlorosilanes generated in a polycrystalline silicon manufacture process, a trichlorosilane manufacture process, or a conversion process are introduced into a decomposition furnace and are decomposition reacted at a high temperature, the method including: heating the decomposition furnace and a fin provided in the decomposition furnace; supplying the polymers and the hydrogen chloride to the decomposition furnace from an upper portion thereof so as to react the polymers and the hydrogen chloride by leading to an inner-bottom portion of the decomposition furnace while heating and stirring; and discharging a reacted gas from the inner-bottom portion upwardly above the decomposition furnace through a center of the decomposition furnace.

### BACKGROUND OF THE INVENTION

1. Field of the Invention

The present invention relates to a method for manufacturing trichlorosilane by decomposing compounds (hereinbelow, referred to as “polymers”) containing high-boiling chlorosilanes, which are generated in a polycrystalline silicon manufacturing process, a trichlorosilane manufacturing process, or a conversing process. In particular, the present invention relates to a method for manufacturing trichlorosilane by decomposing polymers that have been separated in a chlorination step, polymers that have been separated from an exhaust gas of a polycrystalline silicon reaction step, or polymers that have been separated in a conversion step producing trichlorosilane from silicon tetrachloride in the exhaust gas.

Priority is claimed on Japanese Patent Application No. 2008-201864, filed Aug. 5, 2008, the content of which is incorporated herein by reference.

2. Description of Related Art

The high-purity polycrystalline silicon that can be used as a semiconductor material is mainly manufactured by the Siemens process in which, for example, trichlorosilane (SiHCl₃; abbreviated “TCS”) and hydrogen are used as raw materials, a gas mixture thereof is introduced into a reactor and brought into contact with heated silicon rods, and silicon is deposited on the surfaces of the silicon rods due to the hydrogen reduction or thermal decomposition of the trichlorosilane at a high temperature. The high-purity trichlorosilane to be introduced into the reactor, for example, is manufactured by introducing metallurgical grade silicon and hydrogen chloride into a fluidized chlorination reactor to react them, chlorinating the silicon to produce crude TCS (chlorination step), and purifying the crude TCS by distillation into high purity TCS.

In the manufacture of polycrystalline silicon, the reactor exhaust gas includes, in addition to unreacted trichlorosilane and hydrogen, by-products such as silicon tetrachloride (SiCl₄; STC) and chlorosilanes including, for example, tetrachlorodisilane (Si₂H₂Cl₄) and hexachlorodisilane (Si₂Cl₆) (refer to PCT International Publication WO 02/012122). The chlorosilanes having boiling point higher than that of silicon tetrachloride are referred to herein as “high-boiling chlorosilanes”. Trichlorosilane is obtained by distillation of chlorosilanes including trichlorosilane which is generated in the conversion furnace from silicon tetrachloride and hydrogen in the exhaust gas (conversion step), and the trichlorosilane is reused. The gas produced in the chlorination reactor or the conversion furnace includes hydrogen chloride, silicon tetrachloride, and the high-boiling chlorosilanes in addition to trichlorosilane.

Conventionally, polymers which are separated and distilled from produced gas in the chlorination reactor or the conversion furnace and the reactor exhaust gas undergo a hydrolytic process and are then discarded. Thus, there is problem in that the hydrolytic and the waste disposal processes are costly.

A method is known in which the polymers generated in the manufacture of polycrystalline silicon are returned to a fluidized reactor, and then decomposed and used in the manufacture of trichlorosilane (refer to Japanese Unexamined Patent Application, First Publication No. H01-188414). However, in this method, because the silicon powder and polymers supplied to the fluidized reactor are mixed, there is a problem that the fluidity of the silicon powder is reduced and the conversion rate of the silicon powder to chlorosilanes is lowered.

### SUMMARY OF THE INVENTION

### Problems to be Solved by the Invention

The present invention solves the above problems in the conventional polycrystalline silicon manufacture, and provides a manufacturing method in which polymers separated from a polycrystalline silicon manufacture process, a trichlorosilane manufacture process, or a conversion process are decomposed and converted into trichlorosilane.

### Means for Solving the Problem

A method for manufacturing trichlorosilane according to the present invention is a method in which hydrogen chloride and polymers including high-boiling chlorosilanes generated in a polycrystalline silicon manufacture process, a trichlorosilane manufacture process, or a conversion process are introduced into a decomposition furnace and are decomposition reacted at a high temperature. The method of manufacturing trichlorosilane has steps of: providing a center tube having a lower-end opening portion opposed to an inner-bottom surface of the decomposition furnace in the decomposition furnace along a longitudinal direction of the decomposition furnace and a fin in the decomposition furnace between an outer peripheral surface of the center tube and an inner peripheral surface of the decomposition furnace; heating the decomposition furnace and the fin; supplying the polymers and the hydrogen chloride to the decomposition furnace from an upper portion thereof so as to react the polymers and the hydrogen chloride by leading to an inner-bottom portion of the decomposition furnace while heating and stirring; and discharging a reacted gas from the inner-bottom portion upwardly above the decomposition furnace through the center tube in the decomposition furnace.

For example, in order to carry out the manufacturing method, an apparatus for manufacturing trichlorosilane by decomposition reacting polymers with hydrogen chloride at a high temperature is provided with a decomposition furnace into which the polymers including high-boiling chlorosilanes generated in a polycrystalline silicon manufacture process, a trichlorosilane manufacture process, or a conversion process and hydrogen chloride are introduced. The decomposition furnace includes: a heating device which heats an interior of the decomposition furnace; a reaction chamber which is formed in the decomposition furnace; a center tube which is inserted in the reaction chamber along a longitudinal direction of the reaction chamber from an upper portion of the decomposition furnace and has a lower-end opening portion opposed to an inner-bottom surface of the decomposition furnace; a raw-material-supply pipe which supplies the polymer and the hydrogen chloride to an upper portion of the reaction chamber at an exterior of the center tube; and a gas-discharge pipe which leads reacted gas from an upper end portion of the center tube. The apparatus further includes a fin which is formed integrally with at least one of an outer peripheral surface of the center tube or an inner peripheral surface of the decomposition furnace. The fin leads the polymer and the hydrogen chloride to the lower-end opening portion of the center tube so as to stir the polymer and the hydrogen chloride.

In the method for manufacturing trichlorosilane, trichlorosilane is produced by decomposing polymers. Therefore, for example, it is possible to recover trichlorosilane by decomposing polymers which are separated in a polycrystalline silicon manufacturing process. Accordingly, it is possible to significantly reduce the load incurred due to carrying out waste disposal by hydrolytic the polymers. Furthermore, it is possible to increase the consumption efficiency of raw materials by recycling the recovered trichlorosilane. Therefore, it is possible to reduce the polycrystalline silicon manufacturing cost. In this case, the polymers and the hydrogen chloride are supplied to an upper surface of the fin at the upper portion of the reaction chamber, and are led to the inner-bottom portion along the fin while being stirred. Therefore, the polymers and the hydrogen chloride are heated efficiently since the heat is conducted from the fin, meanwhile, the temperature in the furnace can be uniformed. As a result, the polymers and the hydrogen chloride can be reacted with high efficiency. Though silicon oxide is generated since oxide included in the polymers reacts with moisture in the hydrogen chloride gas, the center tube can be prevented from being clogged due to the silicon oxide since the silicon oxide is generated at comparatively large space around the center tube. Therefore, the silicon oxide rarely inhibits the operation of the decomposition furnace. Furthermore, although the silicon oxide slightly adheres to the inner surface of the lower-end opening portion of the center tube, the silicon oxide can be easily removed by inserting a stick or the like into the inside of the center tube since the center tube is provided vertically.

In the method for manufacturing trichlorosilane, it is preferable that the polymers and the hydrogen chloride be preheated by thermal exchange between the reacted gas discharged from the decomposition furnace and the polymers and the hydrogen chloride before being introduced into the decomposition furnace.

In order to carry out the method for manufacturing trichlorosilane according to the present invention, for example, it is preferable that the center tube be provided so as to be extended above the decomposition furnace; and the raw-material-supply pipe surrounds the center tube at an exterior of the decomposition furnace, and forms a double pipe with the center tube.

The gas after the reaction that is discharged from the decomposition furnace through the center tube is highly-heated. Therefore, the polymers and the hydrogen chloride flowing through the raw-material-supply pipe are thermally exchanged with the highly-heated reacted gas via the wall of the center tube. As a result, the polymers and the like can be preheated before being introduced into the decomposition furnace, and the reaction efficiency can be increased.

In the method for manufacturing trichlorosilane, it is preferable to discharge deposits such as silicon oxide and the like which accumulate on the inner-bottom portion of the decomposition furnace by injecting a pressurized gas into the decomposition furnace.

In order to carry out the manufacturing method for manufacturing trichlorosilane according to the present invention, for example, it is preferable that the apparatus further have a pressurized-gas injection pipe which injects a pressurized gas into the decomposition furnace, and a discharge pipe which discharges a fluid in the decomposition furnace purged by the pressurized gas.

Though the silicon oxide which is generated by the reaction is adhered to the decomposition furnace, it is possible to clean the inner of the decomposition furnace by injecting the pressurized gas continuously or intermittently into the decomposition furnace so as to purge the adhered silicon oxide. Inactive gas, nitrogen gas, and the like can be used as the pressurized gas.

Furthermore, in the method for manufacturing trichlorosilane according to the present invention, it is preferable to break silicon oxide which accumulates on the inner-bottom portion of the reaction chamber by rolling a plurality of rolling members which are provided at the inner-bottom portion.

In order to carry out the method for manufacturing trichlorosilane according to the present invention, it is preferable that a plurality of rolling members be provided at the inner-bottom portion of the reaction chamber.

The silicon oxide is easy to accumulate on the inner-bottom portion of the decomposition furnace. The silicon oxide can be broken by rolling the rolling members, for example, by inserting a rod or the like from the outside, and then the silicon oxide can be easily removed.

In the method for manufacturing trichlorosilane, it is preferable to: provide heaters surrounding the decomposition furnace at a plurality of height positions of the decomposition furnace; detect inner temperature at a plurality of height positions of the decomposition furnace and control outputs of the heaters in accordance with detecting results of the inner temperature; and detect each heater temperature and control the outputs of the heaters or supply of raw material in accordance with the heater temperature.

In this case, the outputs of the heaters can be appropriately controlled in accordance with the temperature distribution. Also, with silicon oxide being accumulated, when temperature of a lower position is reduced, the heater at the lower position can be controlled so that the output is increased. Furthermore, when the heater sustains the state in which the output is large, by controlling the output of the heater or the supply of the raw material, the load of the heater can be reduced, so that the deterioration of the heater can be prevented. As a result, the heaters can sustain stably heating.

In the method for manufacturing trichlorosilane, it is preferable that an outer-peripheral surface of the decomposition furnace and an outer-bottom surface of the decomposition furnace be heated by separated heaters. In this case, introduced polymers and hydrogen chloride can be effectively heated from the outer-peripheral surface and the outer-bottom surface of the decomposition furnace, so that each the output of the heater can be reduced and the load of the heater can be reduced. Therefore, the temperature fluctuation in the decomposition furnace can be reduced, so that the reaction of the polymers and hydrogen chloride can be sustained and a recover rate of trichlorosilane can be improved.

In the method for manufacturing trichlorosilane, the heater is preferably made of aluminum bronze. Since aluminum bronze has high heat resistance, the durability of the heater can be maintained even though the heater runs in a high-temperature state for a long period.

### Effects of the Invention

According to the present invention, trichlorosilane is produced by decomposing polymers. Therefore, for example, it is possible to recover trichlorosilane by decomposing polymers which are separated in a polycrystalline silicon manufacturing process, a trichlorosilane manufacturing process, or a conversion process. Therefore, it is possible to significantly reduce the load due to carrying out waste disposal by hydrolytic the polymers. In addition, it is possible to increase the consumption efficiency of raw materials by recycling the recovered trichlorosilane. As a result, it is possible to reduce the polycrystalline silicon manufacturing cost. In this case, the polymers and the hydrogen chloride are supplied to an upper surface of the fin at the upper portion of the reaction chamber, and are led to the inner-bottom portion along the fin while being stirred. Therefore, the polymers and the hydrogen chloride are heated efficiently since the heat is conducted from the fin, meanwhile, the temperature in the furnace can be uniformed. As a result, the polymers and the hydrogen chloride can be reacted with high efficiency. Though silicon oxide is generated since oxidative product included in the polymers reacts with moisture in the hydrogen chloride gas, the center tube can be prevented from being clogged due to the silicon oxide since the silicon oxide is generated at comparatively large space around the center tube. Therefore, the silicon oxide rarely inhibits the operation of the decomposition furnace.

Also, as detecting the heater temperature around the decomposition furnace in addition to the inner temperature of the decomposition furnace, the outputs of the heaters or quantity of the supply of raw material are controlled. Therefore, temperature fluctuation can be reduced in the furnace body in which decomposition is developed, so that the recover rate of trichlorosilane can be improved. Furthermore, the deterioration of the heater located under the decomposition furnace in which the temperature tends to be increased with controlling the heater can be prevented, so that the durability of the apparatus can be maintained and stable decomposition can be operated for a long period.

### BRIEF DESCRIPTION OF THE DRAWINGS

FIG. 1 is a vertical sectional view showing an apparatus carrying out a manufacturing method for trichlorosilane according to a first embodiment of the present invention.

FIG. 2 is the other vertical sectional view showing the manufacturing apparatus for trichlorosilane viewed at 90° different angle from FIG. 1.

FIGS. 3A and 3B are schematic piping diagrams showing examples of discharging silicon oxide in a decomposition furnace using a pressurized-gas injection pipe showed in FIG. 2.

FIG. 4 is a flow diagram showing an example of a manufacturing process for polycrystalline silicon by the manufacturing method for trichlorosilane according to the present invention.

FIG. 5 is a vertical sectional view showing an apparatus carrying out a manufacturing method for trichlorosilane according to a second embodiment of the present invention.

FIG. 6 is a front view showing a center tube having a modified fin used in a manufacturing apparatus for trichlorosilane carrying out the present invention.

FIG. 7 is a bottom view of FIG. 6.

FIG. 8 is a vertical sectional view showing an essential portion of an example in which rolling members are provided in the decomposition furnace of the manufacturing apparatus for trichlorosilane of FIG. 1.

FIG. 9 is a vertical sectional view showing an apparatus carrying out a manufacturing method for trichlorosilane according to a third embodiment of the present invention.

FIG. 10 is a transverse sectional view taken along the X-X line of the manufacturing apparatus for trichlorosilane in FIG. 9.

FIG. 11 is a vertical sectional view showing an essential portion in a state in which silicon oxide accumulates in an inner bottom portion of a decomposition furnace in the manufacturing apparatus of FIG. 9.

FIGS. 12A and 12B are graphs showing detected results of temperature detection sensors while the manufacturing apparatus in FIG. 9 is operated.

FIG. 13 is a vertical sectional view showing an apparatus carrying out a manufacturing method for trichlorosilane according to a fourth embodiment of the present invention.

FIGS. 14A and 14B are graphs showing detected results of temperature detection sensors while the manufacturing apparatus in FIG. 13 is operated.

### DETAIL DESCRIPTION OF THE INVENTION

Below, embodiments of the present invention will be explained with reference to drawings.

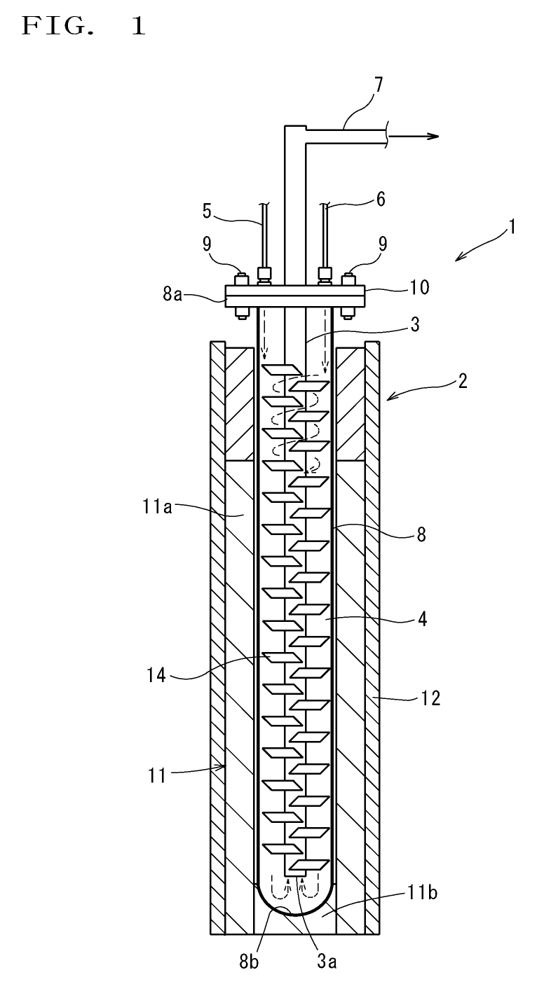

FIG. 1 to FIG. 3 show a first embodiment of a manufacturing apparatus for trichlorosilane carrying out a manufacturing method of the present invention. The manufacturing apparatus 1 is provided with: a decomposition furnace 2 which has a tube-shape and is disposed vertically; a center tube 3 which is inserted into the decomposition furnace 2 from an upper portion to an inner-bottom portion of the decomposition furnace 2 along a center axis thereof; a polymer-supply pipe 5 which supplies polymers to an upper portion of a reaction chamber 4 which is formed at an outside of the center tube 3; a hydrogen-chloride-supply pipe 6 to the upper portion of the reaction chamber 4; and a gas-discharge pipe 7 which discharges a reacted gas from an upper-end portion of the center tube 3.

The decomposition furnace 2 is configured with: a furnace body 8 which is formed as a tube-shape having a bottom and a upper flange 8a at an upper portion thereof; an end plate 10 which is detachably jointed to the upper flange 8a of the furnace body 8 by bolts 9; and a heating device 11 which is disposed around the furnace body 8 and heats an inside of the furnace body 8. An inner-bottom surface 8b of the furnace body 8 is formed as concave-spherical shell shape.

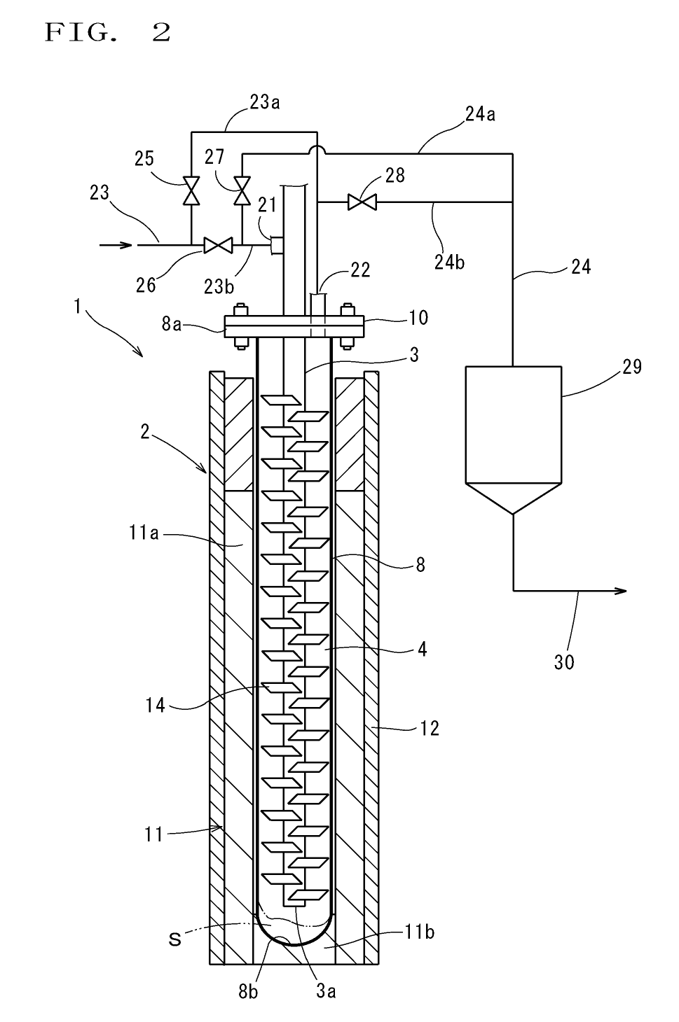

The heating device 11 is configured with a body heater 11a surrounding an outer peripheral surface of the furnace body 8, and a bottom heater 11b covering an outer-bottom surface of the furnace body 8. A reference number 12 in FIG. 1 and FIG. 2 denotes a frame which covers an outside of the heating device 11.

The center tube 3 is formed as a straight pipe, and fixed vertically to the end plate 10 of the decomposition furnace 2 so as to penetrate the end plate 10. The gas-discharge pipe 7 deriving the reaction gas is connected to an upper end portion of the center tube 3 protruding upward from the decomposition furnace 2. The reacted gas flows upwardly inside of the center tube 3, and is discharged outside through the gas-discharge pipe 7. The gas-discharge pipe 7 is connected to a gas cooler (not illustrated) which cools the high-temperature reacted gas and a gas suction device (not illustrated) which suctions the reacted gas. The center tube 3 is inserted into the furnace body 8 from the end plate 10 at the length slightly less than the depth of the furnace body 8. Therefore, when the end plate 10 is fixed to the upper flange 8a of the furnace body 8, the center tube 3 is disposed so that a lower-end opening portion 3a of the center tube 3 is slightly separated from the inner-bottom surface 8b of the furnace body 8.

The reaction chamber 4 is a tube-like space between an outer peripheral surface of the center tube 3 at a portion of being inserted into the decomposition furnace 2 and an inner peripheral surface of the furnace body 8a of the decomposition furnace 2. The fin 14 is fixed to the outer peripheral surface of the center tube 3 facing the reaction chamber 4. The fin 14 is formed, for example, spirally along a longitudinal direction of the center tube 3, and an outer peripheral end thereof is adjacent to the inner peripheral surface of the furnace body 8. An inside of the reaction chamber 4 is substantially partitioned as a spiral space since the gap between the outer peripheral end of the fin 14 and the inner peripheral surface of the furnace body 8 is set small.

As shown in FIG. 2, a communication hole 21 communicating with the inside of the center tube 3 is formed midway of a protruding portion of the center tube 3 upward from the end plate 10. Also, a communication hole 22 communicating with the reaction chamber 4 is formed at the end plate 10 other from the supply pipes 5 and 6. A pressurized-gas injection pipe 23 and a discharge pipe 24 of furnace fluid are connected to the communication hole 21 through branch pipes 23b and 24a. Also, the pressurized-gas injection pipe 23 and the discharge pipe 24 are connected to the communication hole 22 through branch pipes 23a and 24b. The pressurized-gas injection pipe 23 is provided in order to inject inactive gas, nitrogen gas and the like in a state of being pressurized into the center tube 3 or the reaction chamber 4 through either the communication hole 21 or the communication hole 22. Valves 25 and 26 are provided on the pressurized-gas injection pipe 23 in order to switch flow paths to either the center tube 3 or the reaction chamber 4. The discharge pipe 24 of the furnace fluid is provided in order to discharge the furnace fluid including the silicon oxide which is purged by injecting the pressurized gas, from the center tube 3 or the reaction chamber 4. Valves 27 and 28 are provided on the discharge pipe 24 in order to switch flow paths to either the center tube 3 or the reaction chamber 4. The discharge pipe 24 is connected to a cyclone separator 29. The silicon oxide is collected at the cyclone separator 29, and treated by a silicon oxide treating system 30.

The pressurized-gas injection pipe 23 and the discharge pipe 24 of the furnace fluid are clogged at the valves 25 to 28 while the decomposition furnace 2 is in operation. The valves 25 to 28 are opened, for example, for maintenance as after-mentioned in order to clean the inside of the decomposition furnace 2, and then the pressurized-gas injection pipe 23 and the discharge pipe 24 are utilized. Note, the communication hole 22 is separately provided from the polymer-supply pipe 5 and the hydrogen-chloride-supply pipe 6 shown in FIG. 1. However, at least one of the polymer-supply pipe 5 or the hydrogen-chloride-supply pipe 6 can be used as the communication hole 22.

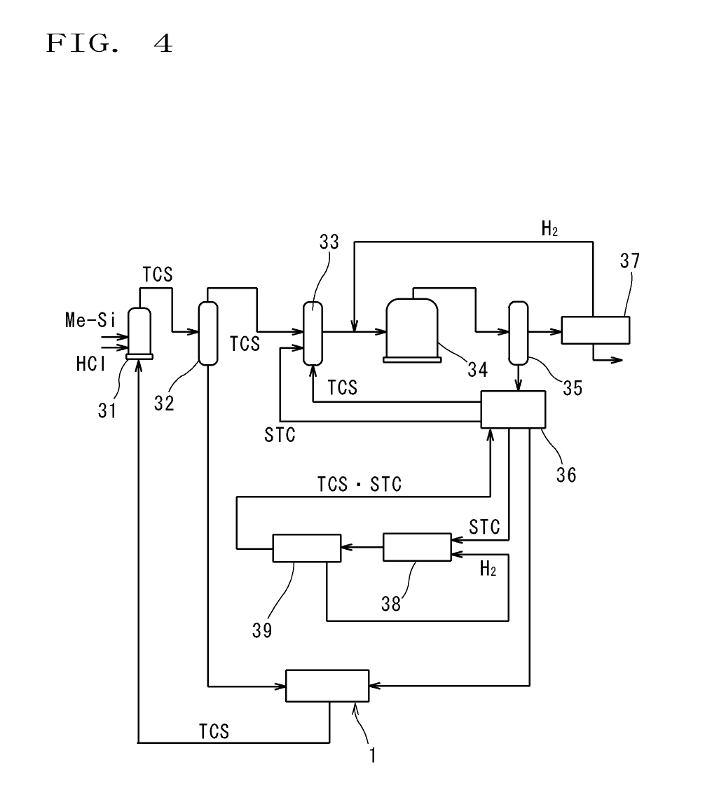

Next, an example of polycrystalline silicon manufacturing process using the trichlorosilane manufacturing apparatus 1 will be explained with reference to FIG. 4. Hereinafter, trichlorosilane is referred as TCS, and silicon tetrachloride is referred as STC.

In the illustrated manufacturing process, a fluidized chlorination furnace 31 producing crude TCS by reacting metallurgical silicon (Me-Si) and hydrogen chloride (HCl); a distillation column 32 which distills produced gas including the crude TCS generated at the fluidized chlorination furnace 31; an evaporator 33 which evaporates refined high-purity TCS with STC and TSC which are recovered in a post-process; a reactor 34 which produces polycrystalline silicon from raw-material gas which is a mixture of hydrogen (H₂) and the gas supplied from the evaporator 33; and a condenser 35 which separates chlorosilanes from an exhaust gas of the reactor 34, are utilized.

The liquid chlorosilanes which are condensed and separated in the condenser 35 are introduced to a distillation system 36 including a plurality of distillation column, are distilled step-by-step in the distillation system 36, and are separated into TCS, STC, and polymers. The TCS and the STC which are recovered are returned to the evaporator 33, and reused as raw-material gas components. Gas educed from the condenser 35 includes hydrogen, hydrogen chloride, and the like, are introduced to a hydrogen recovering system 37, and then hydrogen is separated therefrom. The separated hydrogen is returned to the evaporator 33, and reused as a raw-material gas.

A part of the STC from the distillation system 36 is reacted with hydrogen (H₂) and converted to TCS in a conversion furnace 38. A hydrogen recovering equipment 39 recovers hydrogen from the reacted gas of the conversion furnace 38. The reacted gas of the hydrogen recovering equipment 39 includes TCS and STC, and is returned to the distillation system 36.

Note, STC is also added to the evaporator 33 and used as the raw-material gas of the polycrystalline silicon manufacture. However, STC is not always necessary to be added to the raw-material gas.

In a series of the manufacturing process, distillation residues which are separated from bottoms of the columns (i.e., the distillation column 32 after a chlorination process generating TCS, and the distillation columns of the distillation system 36 after the reaction process generating polycrystalline silicon or after the conversion process converting STC to TCS) includes polymers. The polymers are decomposed by the trichlorosilane manufacturing apparatus 1, and converted to TCS. The TCS obtained in such way is, for example, supplied to the fluidized chlorination furnace 31, and reused as material of producing polycrystalline silicon.

Next, a manufacturing method of TCS by decomposing polymers using the trichlorosilane manufacturing apparatus 1 will be explained.

The polymers which are separated in the distillation column 32 after the chlorination process or in the distillation system 36 after the reaction process or the conversion process include high-boiling chlorosilanes at substantially 20 to 40% by mass. Specifically, for example, the polymers include substantially; 1 to 3 mass % TCS; 50 to 70 mass % STC; 12 to 20 mass % Si₂H₂Cl₄; 13 to 22 mass % Si₂Cl₆; and 3 to 6 mass % other high-boiling chlorosilanes.

The polymers are introduced with hydrogen chloride into the decomposition furnace 2 of the trichlorosilane manufacturing apparatus 1. The ratio is preferably 100% polymers to 10 to 30 mass % hydrogen chloride. It is not preferable that the amount of hydrogen chloride exceed the above ratio since unreacted hydrogen chloride is increased. On the other, in a case in which the amount of the polymers exceeds the above ratio, a large amount of silicon powder is generated, so that a load for maintain the equipment increases, and operation efficiency is significantly deteriorated.

The polymers are reacted with hydrogen chloride at a high temperature of 450° C. or more and thereby converted to TCS. The temperature in the decomposition furnace 2, specifically, the temperature in the reaction chamber 4 is preferably 450° C. or more and 700° C. or less. When the temperature in the furnace is lower than 450° C., the decomposition of the polymers does not progress sufficiently. When the temperature in the furnace rises above 700° C., a reaction in which the produced TCS reacts with the hydrogen chloride to produce STC is progressed, and this is not preferable because the recovery efficiency of the TCS will be decreased.

The polymers includes high-boiling chlorosilanes having boiling point higher than that of STC, for example, tetrachlorodisilane (Si₂H₂Cl₄), hexachlorodisilane (Si₂Cl₆), and the like, and further includes TCS, STC, and the like. The decomposition process of the high-boiling chlorosilanes to TCS includes the following reactions.

(1) Decomposition of tetrachlorodisilane (Si₂H₂Cl₄)

Si₂H₂CL₄+HCl→SiH₂Cl₂+SiHCl₃

Si₂H₂Cl₄+2HCl→2SiHCl₃+H₂

(2) Decomposition of hexachlorodisilane (Si₂Cl₆)

Si₂Cl₆+HCl→SiHCl₃+SiCl₄

In these reactions, silicon oxide is deposited if moisture (H₂O) in hydrogen chloride reacts with trichlorosilane and silicon tetrachloride.

SiHCl₃+2H₂O→SiO₂+H₂+3HCl

SiCl₄+2H₂O→SiO₂+4HCl

First, the inside of the decomposition furnace 2 is heated by the heating device 11, and the polymers and hydrogen chloride are supplied through the polymer-supply pipe 5 and hydrogen-chloride-supply pipe 6 therein. The polymers and hydrogen chloride fall down on the upper surface of the fin 14 from the upper portion of the reaction chamber 4, and flow down along the upper surface of the fin 14. In this case, the fin 14 is adjacent to the inner peripheral surface of the furnace body 8, and is highly-heated by the heating device 11 disposed on the outside the furnace body 8. Therefore, the polymers and hydrogen chloride are heated and evaporated by the heat, so that the polymers and hydrogen chloride are mixed. The gaseous fluid mixture flows down in the reaction chamber 4 since the inside of the decomposition furnace 2 is suctioned by the suction device. The fluid mixture flows down as a spiral flow along the fin 14 with being stiffed since the fin 14 is formed spirally and disposed so as to partition substantially the inner space of the reaction chamber 4. Therefore, the fluid mixture is heated by the inner peripheral surface of the furnace body 8, the surface of the fin 14, and the like, so that the reaction is accelerated, and is led to the inner-bottom portion of the furnace body 8 so that TCS is produced. The lower-end opening portion 3a of the center tube 3 is opposed to the inner-bottom portion of the furnace body 8. The reacted gas is led from the lower-end opening portion 3a into the center tube 3, flows through the center tube 3, and is discharged from the upper gas-discharge pipe 7.

The produced gas including TCS that is discharged from the gas-discharge pipe 7 still includes hydrogen chloride. In order to use the hydrogen chloride for the chlorination, the produced gas is reused in the polycrystalline silicon manufacturing process by being introduced directly into the fluidized chlorination furnace 31 in the polycrystalline silicon manufacturing process (refer to FIG. 4), or being condensed so that the condensate thereof is introduced into the distillation column 32 after the chlorination process.

In the trichlorosilane manufacturing apparatus 1, the polymers and hydrogen chloride are supplied from the upper portion of the reaction chamber 4 so as to flow down on the fin 14, are mixed and evaporated on the surface of the fin 14, and are guided spirally along the fin 14 as shown by a broken line in FIG. 1. The fluid mixture of the polymers and hydrogen chloride is heated by the heating device 11 while moving along the fin 14 by receiving the heat of the inner peripheral surface of the furnace body 8 and the surface of the fin 15. Furthermore, the reaction chamber 4 is a long spiral path comparing with the vertical length thereof since the reaction chamber 4 is formed spirally by the fin 14. Therefore, the temperature distribution in the reaction chamber 4 is uniform, so that a high-efficiency reaction can be operated.

In manufacturing TCS in this manner, in a case in which the silicon oxide S deposits at the inner-bottom portion of the furnace body 8 as shown by a chain line in FIG. 2, the operation of the decomposition furnace 2 is stopped, and the pressurized gas such as inactive gas is injected from the pressurized-gas injection pipe 23. Consequently, the pressure of the pressurized gas breaks and crushes the deposition of the silicon oxide S on the inner-bottom portion. As a result, the silicon oxide S is blown off, and can be discharged outside with the furnace fluid from the discharge pipe 24 of furnace fluid.

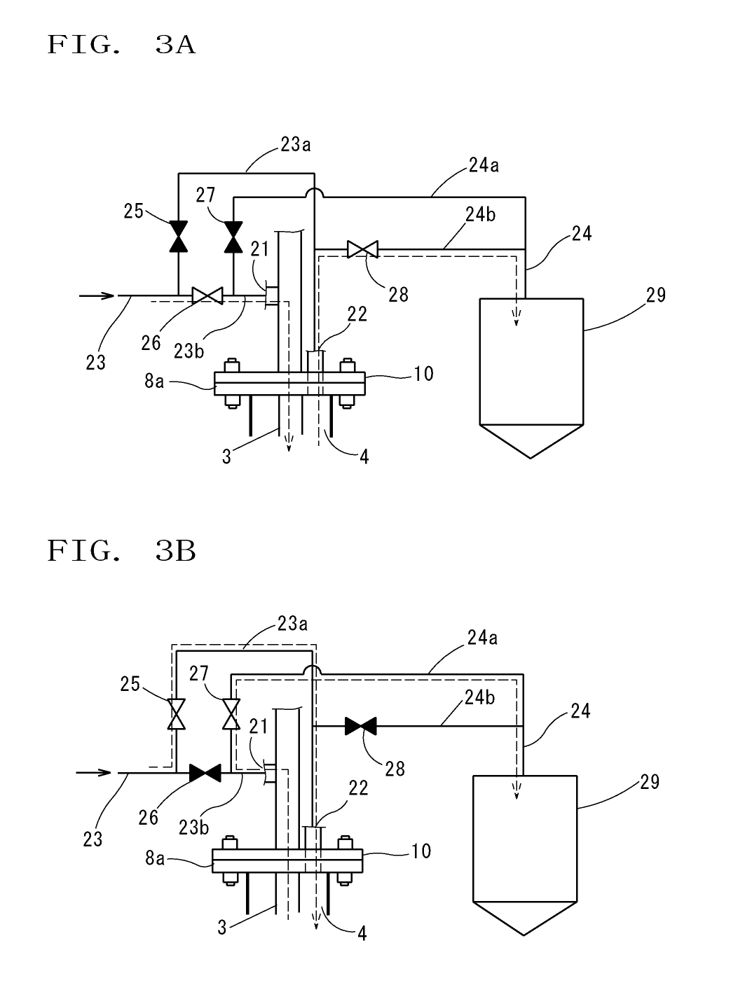

A discharge method of the silicon oxide will be explained with reference to FIGS. 3A and 3B. In FIGS. 3A and 3B, the valves painted black are closed, and the unpainted valves are opened. As shown in FIG. 3A, the valves 25 to 28 are operated. First, the valves 26 and 28 are opened and the valves 25 and 27 are closed to connect the pressurized-gas injection pipe 23 to the communication hole 21 of the center tube 3, and the communication hole 22 of the reaction chamber 4 is communicated with the discharge pipe 24 of the furnace fluid. Next, as shown by dotted lines in FIG. 3A, the pressurized gas is injected from center tube 3 into decomposition furnace 2 through the branch pipe 23b so that the silicon oxide S on the inner-bottom portion is flown while being broken and crushed. Then, the silicon oxide S is discharged from reaction chamber 4 to the cyclone separator 29 via the discharge pipe 24 of the furnace fluid. After a predetermined time, as shown in FIG. 3B, the states of the valves 25 to 28 are switched so that the pressurized gas is injected from the communication hole 22 of the reaction chamber 4, and the furnace fluid or the like are discharged from the communication hole 21 of the center tube 3, in the opposite direction from the case of FIG. 3A. The inside of the decomposition furnace 2 is cleaned by repeating those processes alternately. In this case, it is not always necessary to alternate the state shown in FIG. 3A and the state shown in FIG. 3B; the decomposition furnace 2 can be cleaned by either one of these states.

The discharged silicon oxide S is recovered by the cyclone separator 29, and is sent to the treating system 30. Although a quantity of the silicon oxide S is adhered to the center tube 3 inside the lower-end opening portion 3a, the silicon oxide S can be removed by the above-mentioned operation. In addition, since the center tube 3 is a straight tube, for example, it is easy to remove the silicon oxide S by inserting a rod-like tool from the upper portion.

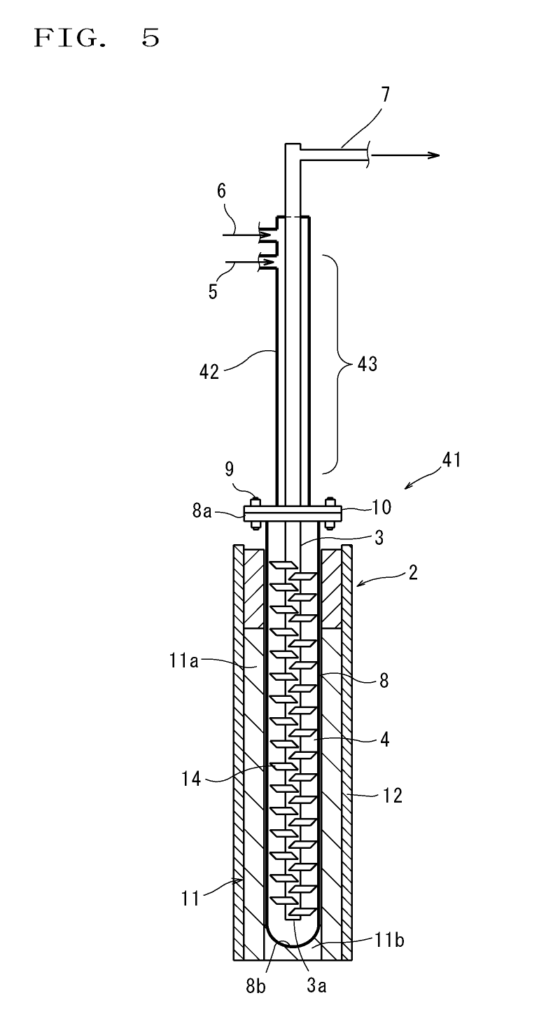

FIG. 5 shows a second embodiment of a trichlorosilane manufacturing apparatus carrying out a manufacturing method according to the present invention.

In the trichlorosilane manufacturing apparatus 1 of the first embodiment, the polymer-supply pipe 5 and the hydrogen-chloride-supply pipe 6 are connected to the end plate 10 of the decomposition furnace 2. In a trichlorosilane manufacturing apparatus 41 of the second embodiment, the center tube 3 is protruded upward from the decomposition furnace 2, and a material-mixing pipe 42 having a larger diameter than that of the center tube 3 is provided so as to cover the center tube 3 at the protruded portion from the decomposition furnace 2. That is, the material-mixing pipe 42 and the center tube 3 are arranged as a double-pipe. The double-pipe portion extends upward from the decomposition furnace 2 by a predetermined length. The polymer-supply pipe 5 and the hydrogen-chloride-supply pipe 6 are connected to the material-mixing pipe 42 which is provided at an upper end portion of the double-pipe. Therefore, the heat of the material fluid flowing through the material-mixing pipe 42 and the heat of the reacted gas flowing through the center tube 3 are exchanged at the double-pipe portion. That is, the double-pipe portion is a preheat device 43 of the material fluid. The other components are the same as those of the first embodiment, and the common parts are denoted by the same reference symbols and the explanations thereof are omitted.

In the trichlorosilane manufacturing apparatus 41, the polymers and hydrogen chloride which are introduced in the material-mixing pipe 42 are mixed, and heated at the preheat device 43 by the reacted gas which is discharged from the decomposition furnace 2 and paths through the center tube 3. The polymers and hydrogen chloride are evaporated and gasified, so that the gaseous fluid mixture is introduced into the reaction chamber 4. Accordingly, the efficient reaction in the reaction chamber 4 can be realized.

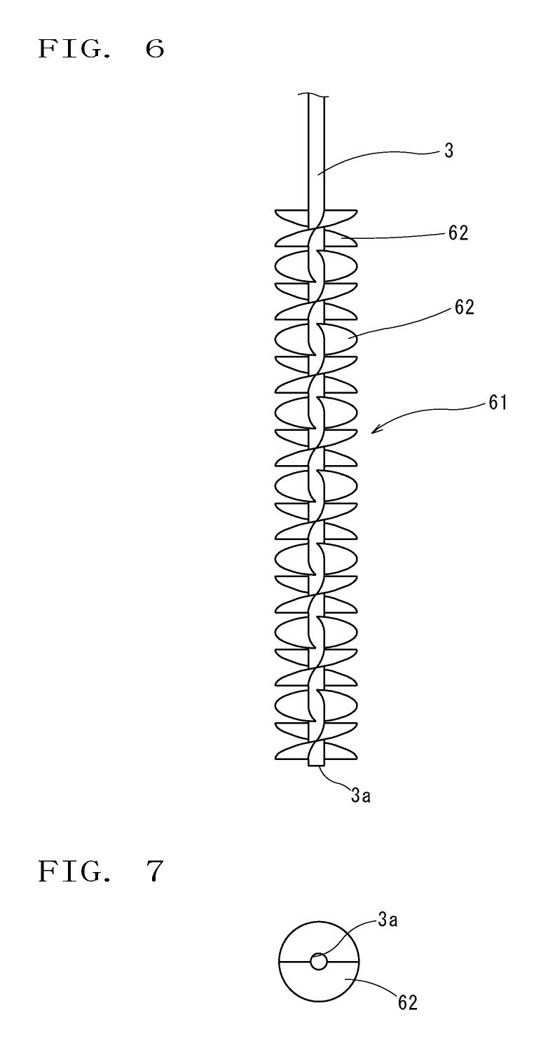

FIGS. 6 and 7 show modifications of fins of a trichlorosilane manufacturing apparatus carrying out the trichlorosilane manufacturing method according to the present invention.

Fin 61 forms a construction of a static mixer. That is, the fin 61 is formed from a plurality of fin elements 62 which are formed by twisting substantially rectangular plates clockwise or counterclockwise so that one end of the plate rotates 180° with respect to the other end. The fin elements 62 having the different twisted-directions are arranged alternately along the longitudinal direction, and the phases thereof are alternately shifted by 90°. The fin 61 having a static mixer formation stirs and mixes fluid by a mixture effect of: a dividing effect in which the fluid is divided in two by passing one fin element 62; a mixing effect (or a conversion effect) in which the fluid is moved along the twisted surface from the center toward the outside or from the outside toward the center; and a reversing effect in which the rotation direction is reversed by one fin element 62 so that the fluid is stirred.

The stirring and mixing in the reaction chamber 4 can be operated efficiently by providing the fin 61 having the static mixer formation around the center tube 3. As a result, it is possible to improve the reaction efficiency.

In the fin 61 of static mixer formation, at least two fin elements 62 are necessary since the fin elements 62 are arranged by 90° different position. It is preferable that 5 to 20 fin elements 62 be provided according to volume of the decomposition furnace.

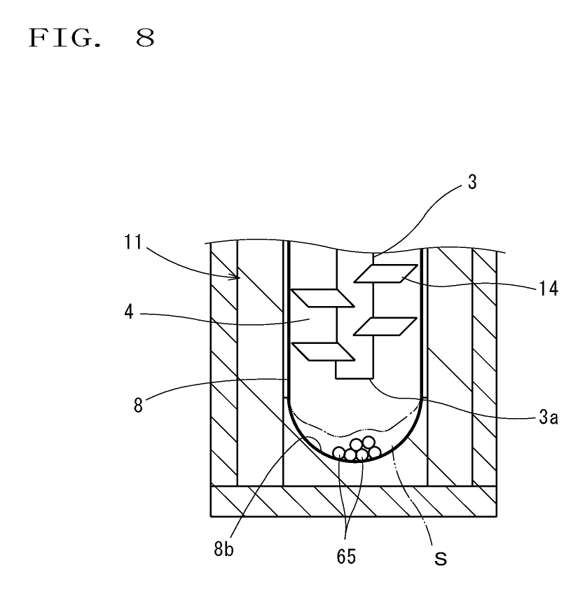

In trichlorosilane manufacturing apparatuses of the above-mentioned embodiments, as shown in FIG. 8, a plurality of spherical rolling members 65 made of stainless steel or the like may be provided on the inner-bottom portion of the furnace body 8. In this case, the rolling members 65 can be rolled on the inner-bottom surface 8b of the furnace body 8 by inserting a rod-like tool into the center tube 3 from the upper portion. Accordingly, the silicon oxide S can certainly be broken by the rolling motion.

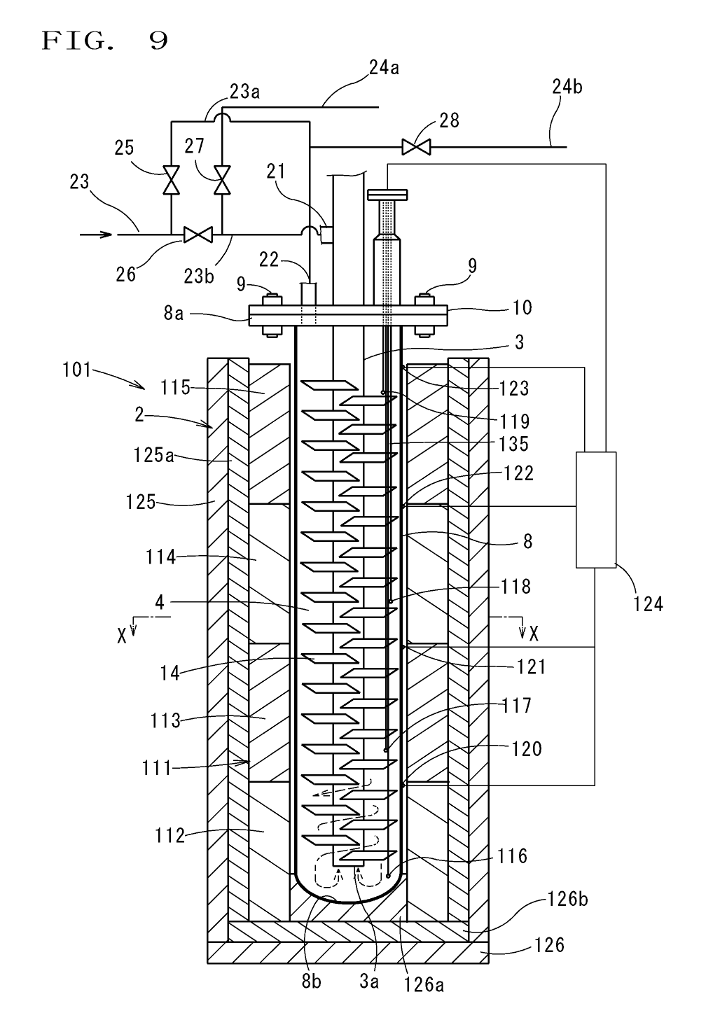

FIGS. 9 to 11 show a manufacturing apparatus 101 for trichlorosilane carrying out a third embodiment of a manufacturing method according to the present invention. The manufacturing apparatus 101 is also provided with a heating device 111 which heats the interior of the decomposition furnace 8 from the exterior. Hereinafter, the same components as those of the first or second embodiments are denoted by the same reference symbols and the explanations thereof are omitted.

The heating device 111 of the manufacturing apparatus 101 includes a plurality of cylindrical heaters (four heaters in the illustrated example) 112 to 115 surrounding the outer peripheral surface of the furnace body 8. The cylindrical heaters 112 to 115 are made of aluminum bronze having a composition of: 77.0 to 92.5% of copper; 6.0 to 12.0% of aluminum; 1.5 to 6.0% of iron; not more than 7.0% of nickel; and not more than 2.0% of manganese, and has heat-resistance not less than 700° C. The cylindrical heaters 112 to 115 are piled along the vertical direction.

Inside-temperature detection sensors 116 to 119 are located in the furnace body 8 of the manufacturing apparatus 101 in order to detect temperatures of the reaction chamber 4 at a plurality of part along the vertical direction. Among the inside-temperature detection sensors 116 to 119, the lowest sensor 116 is preferably located so as to detect temperature below the lower-end opening portion 3a of the center tube 3.

Outside-temperature detection sensors 120 to 123 are located on an outer wall surface of the furnace body 8 at corresponding part to the cylindrical heaters 112 to 115 in order to detect surface temperature of the furnace body 8. A controlling device 124 is provided so as to control outputs of the cylindrical heaters 112 to 115 or supply of the raw material in accordance with the detection results of the inside-temperature detection sensors 116 to 119 and the outside-temperature detection sensors 120 to 123.

The heating device 111 is composed of the cylindrical heaters 112 to 115, the inside-temperature detection sensors 116 to 119, the outside-temperature detection sensors 120 to 123, and the controlling device 124.

A bottom thermal-insulator 126a is provided beneath the outer-bottom surface of the furnace body 8 so as to be in contact with the outer-bottom surface. The bottom thermal-insulator 126a is made from stainless steel or the like having small thermal conductivity. Outside the cylindrical heaters 112 to 115, a thermal insulator 125a covering all outer surfaces of the cylindrical heaters 112 to 115 and a thermal insulator 126b covering both the bottom surface of the cylindrical heater 112 and the bottom surface of the bottom thermal-insulator 126a are arranged. Frames 125 and 126 are provided at the outer of the thermal insulators 125a and 126b.

The inside-temperature detection sensors 116 to 119 are stored in a tube-sheath 135 being held so as to be suspended from the end plate 10. Cutouts 136 are formed at the fin 14 so as to lead the tube-sheath 135 as shown in FIG. 10. FIG. 10 is a cross sectional view taken along the X-X line in FIG. 9.

When trichlorosilane is manufactured by decomposing polymers using the manufacturing apparatus 101 for trichlorosilane, polymers and hydrogen chloride are supplied into the reaction chamber 4, heated and stirred by the fin 14 being highly-heated by the cylindrical heaters 112 to 115, and then introduced into the center tube 3 by the lower-end opening portion 3a.

The temperature in the center tube 3 is controlled to not less than 200° C., e.g., 400° C. by the controlling device 124, so that sublimation and highly-viscous polymers such as aluminum chloride are evaporated. As a result, solid contents or the highly-viscous polymers which remains in the pipes at room temperature are vaporized, so that the pipes are prevented from being choked. Furthermore, most of tetrachlorosilane or the like in the reaction gas is evaporated in the center tube 3.

In the manufacturing apparatus 101 for trichlorosilane of the present embodiment, since temperature in the center tube 3 in which the reaction gas flows is high as 400° C. or more, reactions such as sublimate, evaporation and the like are stably advanced so that the pipes can be prevented from being clogged by adhering of metallic chloride such as aluminum chloride and the like and polymers to the pipes. Furthermore, the raw material is stably supplied into the decomposition furnace 2, temperature fluctuation in the furnace body 8 can be prevented, so that decomposition efficiency of polymers can be improved.

In the manufacturing apparatus 101, the controlling device 124 controls the outputs of the cylindrical heaters 112 to 115 so as to maintain furnace temperature in a prescribed range in accordance with the detection results of the inside-temperature detection sensors 116 to 119, and further controls the cylindrical heaters 112 to 115 so as to prevent overheated state and the like in accordance with the detection results of the outside-temperature detection sensors 120 to 123.

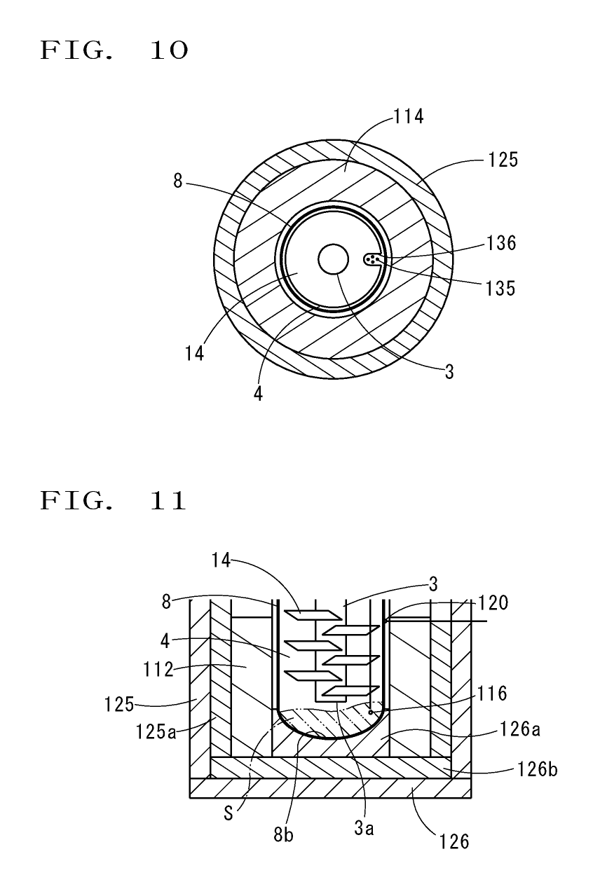

By continuing manufacture trichlorosilane as above, silicon oxide S is accumulated on the inner bottom portion of the furnace body 8 as shown in dotted lines in FIG. 11, and the silicon oxide S prevents the heat transmission of the cylindrical heater 112 to the furnace. As a result, the detected temperature by the inside-temperature detection sensor 116 located at the lower position is especially reduced among the inside-temperature detection sensors 116 to 119. Therefore, in accordance with the detection result of the inside-temperature detection sensor 116, the controlling device 124 controls the lower cylindrical heater 112 so as to increase the output thereof.

When the accumulated silicon oxide S is increased by continuing the operation, the highly-heated state of the cylindrical heater 112 is maintained in order to increase the inside temperature, so that the detection temperature of the outside-temperature detection sensor 120 is increased. In this case, in order to hold down the excessive load of the cylindrical heater 112, the controlling device 124 stops supplying of the raw material and outputs of the cylindrical heaters 112 to 115 in accordance with the detection result of the outside-temperature detection sensor 120, so that the decomposition furnace 2 is stopped.

In the state in which the decomposition furnace 2 is stopped, by injecting pressurized inactive gas or the like (such as nitrogen gas), the pressure of the pressurized gas breaks and crushes the deposition of the silicon oxide S on the inner-bottom portion. As a result, the silicon oxide S is blown off, and can be discharged outside with the furnace fluid from the discharge pipe of furnace fluid.

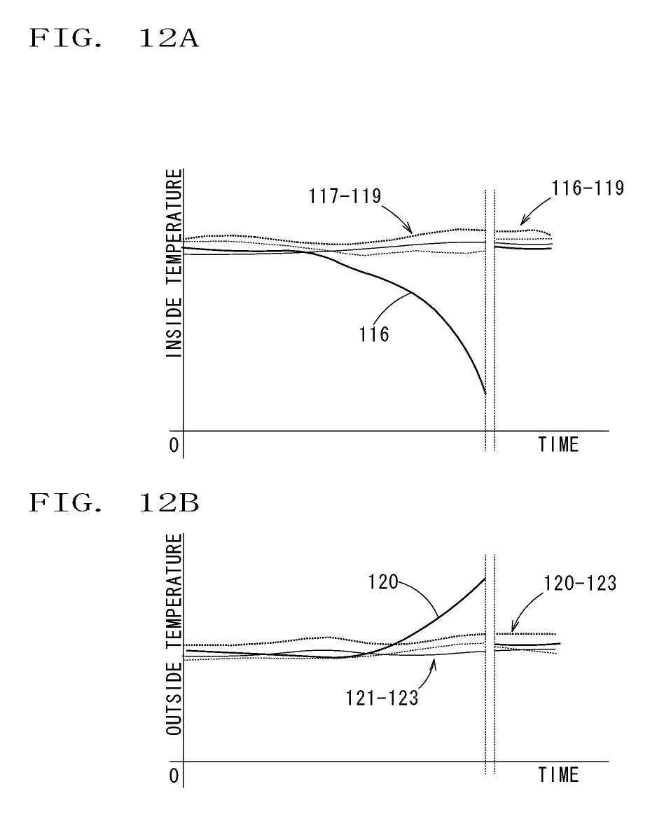

FIGS. 12A and 12B schematically show the detection temperatures of the inside-temperature detection sensors 116 to 119 and the outside-temperature detection sensors 120 to 123 while the decomposition furnace 2 being operated. The detection temperatures of the inside-temperature detection sensors 117 to 119 at the upper part of the decomposition furnace 2 are substantially constant. On the other hand, the detected temperature of the inside-temperature detection sensor 116 at the lower part of the decomposition furnace 2 is reduced by degrees as shown in FIG. 12A on account of the deposition of the silicon oxide S.

In response to the reduction of the detected temperature, even though the output of the cylindrical heater 112 is increased in order to maintain the inside-temperature in the prescribed range, if the amount of the deposition of the silicon oxide S is large, the inside-temperature cannot be increased as shown in FIG. 12A; on the other hand, the detected temperature of the outside-temperature detection sensor 120 is increased as shown in FIG. 12B.

That is to say, when the accumulated silicon oxide is increased along with the decomposition of the polymers, the inside-temperature cannot be increased to the prescribed temperature; but the outside-temperature (i.e., the temperature of the cylindrical heater 112) is increased, so that the load of the cylindrical heater 112 is increased. In this case, since the supply of the raw material and the output of the cylindrical heaters are stopped by the controlling device 124, the operation the decomposition furnace 2 is stopped so as to discharge the accumulated silicon oxide S at the bottom portion of the furnace body 8. In FIGS. 12A and 12B, the silicon oxide is discharged in the time between the two dotted lines.

When the furnace is resumed after discharging the accumulated silicon oxide S from the furnace, the inside-temperature detected by the inside-temperature detection sensor 116 and the outside-temperature detected by the outside-temperature detection sensor 120 corresponding to the lower cylindrical heater 112 are recovered to the substantially constant temperature as that of the other cylindrical heaters 113 to 115.

Next, a fourth embodiment of a manufacturing apparatus carrying out a manufacturing method according to the present invention will be described. Hereinafter, the same components as those of the first to third embodiments are denoted by the same reference symbols and the explanations thereof are omitted.

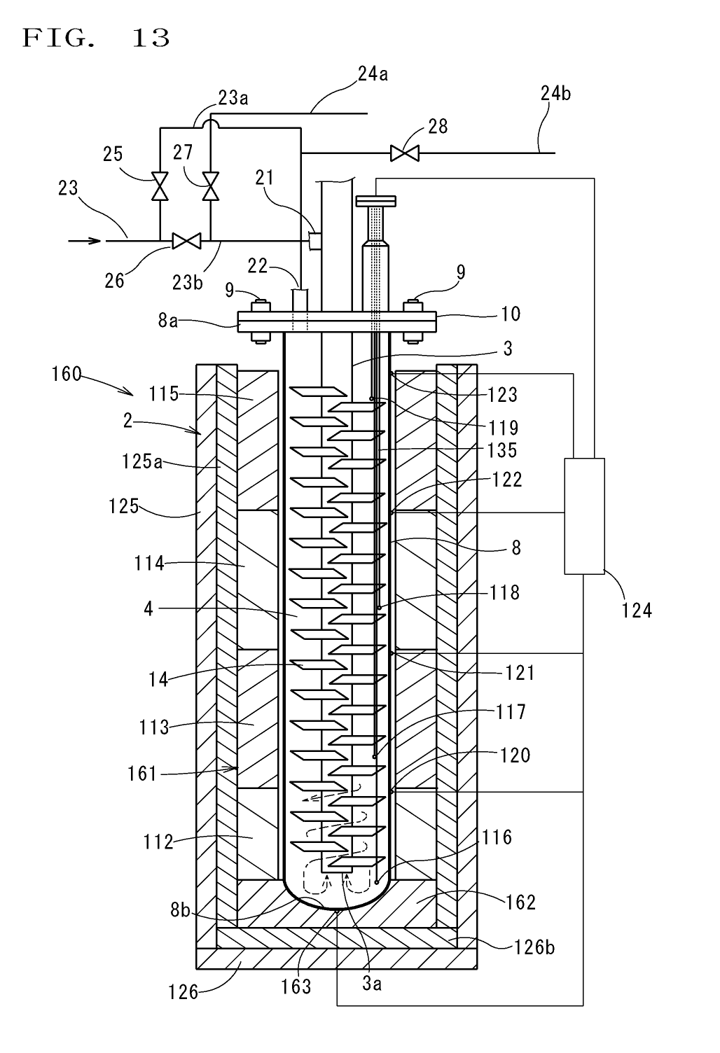

In a heating device 161 of a manufacturing apparatus 160 of the fourth embodiment shown in FIG. 13, as the manufacturing apparatus 101 for trichlorosilane of the third embodiment, the plurality of (four in the illustrated example) cylindrical heaters 112 to 115 are provided surrounding the outer peripheral surface of the furnace body 8, and a furnace-bottom heater 162 surrounding the outer bottom surface of the furnace body 8 is further provided. The furnace-bottom heater 162 is made of, as the cylindrical heaters 112 to 115, aluminum bronze having a composition of: 77.0 to 92.5% of copper; 6.0 to 12.0% of aluminum; 1.5 to 6.0% of iron; not more than 7.0% of nickel; and not more than 2.0% of manganese, has heat-resistance not less than 700° C., and is piled along the vertical direction along with the cylindrical heaters 112 to 115.

An outside-temperature detection sensor 163 is located on the outer wall surface of the furnace body 8 at corresponding part to the furnace-bottom heater 162 in order to detect the surface temperature of the furnace body 8. The thermal insulator 126b is provided beneath the furnace-bottom heater 162 so as to be in contact with the furnace-bottom heater 162. The cylindrical heater 112 to 115 and the furnace-bottom heater 162 are covered with the thermal insulators 126b and 125a.

In the manufacturing apparatus 160 for trichlorosilane of the fourth embodiment, polymers and hydrogen chloride are reacted with being stirred in the reaction chamber 4 by the fin 14 which is formed integrally with the outer peripheral surface of the center tube 3 as in the third embodiment.

Also in the manufacturing apparatus 160 for trichlorosilane, the controlling device 124 controls the output of the cylindrical heaters 112 to 115 and 162 respectively in accordance with the inside-temperature detection sensors 116 to 119 and 163 which are located in the furnace body 8. The outputs of the furnace-bottom heater 162 and the lowest cylindrical heater 112 are controlled in accordance with the detection result of the lowest inside-temperature detection sensor 116.

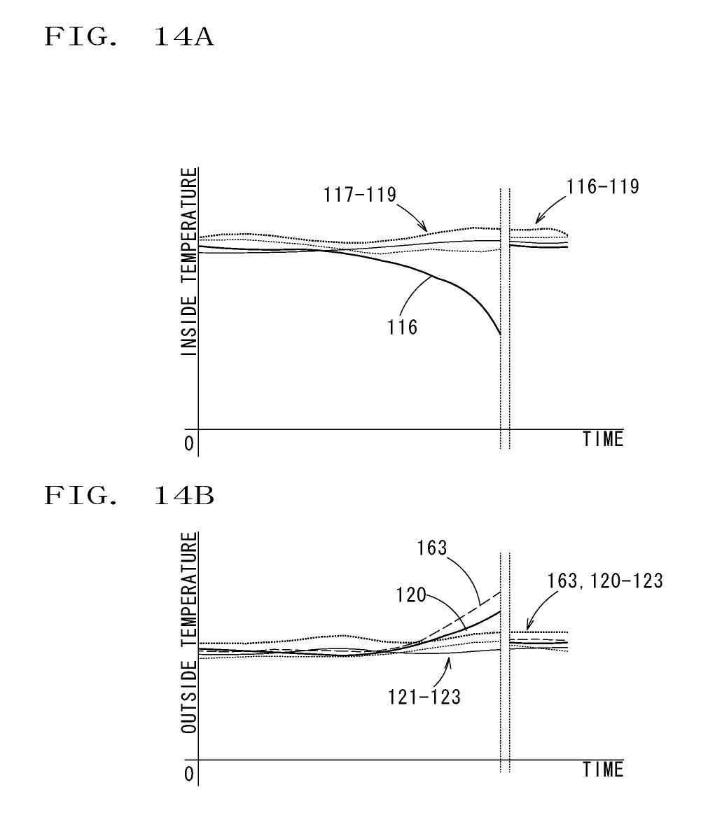

FIGS. 14A and 14B schematically show the detection temperatures of the inside-temperature detection sensor 116 to 119 and the outside-temperature detection sensors 120 to 123 and 163 while the manufacturing apparatus 160 for trichlorosilane is operated.

The detection temperature of the inside-temperature detection sensor 116 which is located at the lower part of the furnace body 8 is reduced by degrees since the accumulated silicon oxide is increased by degrees along with the decomposition of polymers. The controlling device 124 increases the outputs of the cylindrical heaters and the furnace bottom heater 162 corresponding to the reduction of the detection temperature, then the outside-temperature detected by the outside-temperature detection sensors 163 and 120 are increased. When the deposition of the silicon oxide S is excessively increased, the inside temperature cannot be increased even though the outputs of the furnace-bottom heater 162 and the cylindrical heater 112 are increased, so that the inside-temperature is less than the prescribed range even though the outside-temperature is more than the prescribed range. In this case, the decomposition furnace 2 is stopped, and then the silicon oxide S accumulated on the bottom of the furnace body 8 is discharged.

In FIGS. 14A and 14B, the silicon oxide is discharged in the time between the two dotted lines. When the furnace is resumed after discharging the accumulated silicon oxide S from the furnace, the inside-temperature detected by the inside-temperature detection sensor 116 and the outside-temperature detected by the outside-temperature detection sensors 120 and 163 corresponding to the cylindrical heater 112 and the furnace-bottom heater 162 are recovered to the substantially constant temperature as that of the other cylindrical heaters 113 to 115.

FIGS. 14A and 14B shows fluctuations of the detected inside-temperature and outside-temperature under the same condition of flow rates of the polymers and hydrogen chloride as in the third embodiment shown in FIGS. 12A and 12B.

When the deposition of silicon oxide is increased along with the decomposition of polymers, the inside-temperature (i.e., the detection value by the inside-temperature detection sensor 116) cannot increased also in the fourth embodiment even though the outputs of the cylindrical heater 112 and the furnace-bottom heater 162 are increased; and further, the outside-temperature is increased. However, the changes of temperature are less in the fourth embodiment shown in FIGS. 14A and 14B than in the third embodiment shown in FIGS. 12A and 12B.

In the fourth embodiment, the heat is efficiently transferred to polymers from the furnace-bottom heater 162 since the furnace-bottom heater 162 is located at the lower part of the furnace body 8. Furthermore, the output load of the cylindrical heater 112 is compensated by controlling the output of the furnace-bottom heater 162. Therefore, the inside-temperature is prevented from being rapidly reduced in the fourth embodiment comparing with in the third embodiment. As a result, fluctuation of the temperature in the furnace can be prevented as shown in FIG. 14A and fluctuation of the outside-temperature of the cylindrical heater 112 can be prevented as shown in FIG. 14B, so that the load of the cylindrical heater 112 considered to be reduced.

In the third and fourth embodiments, the outside-temperature detection sensors 120 to 123 and 163 are provided. Furthermore, the other sensor which directly detects the temperature of the cylindrical heaters 112 to 115 and the furnace-bottom heater 162 can be provided. Moreover, number of provided cylindrical heaters can be increased in accordance with the throughput of polymers so that the inside-temperature of the decomposition furnace and the outside-temperature can be precisely controlled.

In order to increase the input of the polymers so that the throughput is increased while the loads of the cylindrical heaters are restrained, it is preferable that the lower limit of the prescribed temperature range of the furnace-bottom heater be higher than that of the cylindrical heaters.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

For example, the fin is fixed to the outer peripheral surface of the center tube in the above embodiments. However, the fin may be fixed to the inner peripheral surface of the furnace body so as to form a space between the fin and the center tube.

Further, holes along the injection direction of the pressurized gas may be formed on the fin 14 existing in the injection direction so that the injected gas from the pressurized-gas injection pipe 23 can easily reach the inner-bottom surface 8b of the furnace body 8.

The polymer-supply pipe and the hydrogen-chloride-supply pipe may be individually connected to the furnace body as the first embodiment. Also, the polymers and hydrogen chloride may be supplied to the furnace body while being mixed as the second embodiment. In the present invention, the pipe supplying the polymers and hydrogen chloride individually and the pipe supplying the polymers and hydrogen chloride with mixing are all called as “raw-material-supply pipes”.

Further, the discharge pipe of the furnace fluid for discharging the silicon oxide is provided on the end plate in the above-mentioned embodiments. However, the discharge pipe may be provided on the bottom portion of the furnace body.

In the above embodiments, the fin elements which form the fin are arranged continuously; however, the fin elements may be arranged intermittently, and may have a linear shape, or a pipe shape. For example, the fin may be provided by arranging a plurality of flat plates along a longitudinal direction of the furnace body with intervals. In this case, it is preferable that the adjacent plates be rotated with each other by a predetermined angle so that the plates are overlapped vertically at a part thereof.

What is claimed is:

1. A method for manufacturing trichlorosilane in which hydrogen chloride and polymers including high-boiling chlorosilanes generated in a polycrystalline silicon manufacture process, a trichlorosilane manufacture process, or a conversion process are introduced into a decomposition furnace and are decomposition reacted at a high temperature,
wherein the method comprising:
providing a center tube having a lower-end opening portion opposed to an inner-bottom surface of the decomposition furnace in the decomposition furnace along a longitudinal direction of the decomposition furnace and a fin in the decomposition furnace between an outer peripheral surface of the center tube and an inner peripheral surface of the decomposition furnace;
heating the decomposition furnace and the fin;
supplying the polymers and the hydrogen chloride to the decomposition furnace from an upper portion thereof so as to react the polymers and the hydrogen chloride by leading to an inner-bottom portion of the decomposition furnace while heating and stirring; and
discharging a reacted gas from the inner-bottom portion upwardly above the decomposition furnace through the center tube in the decomposition furnace.

2. The method for manufacturing trichlorosilane according to claim 1, wherein the polymers and the hydrogen chloride are preheated by thermal exchange between the reacted gas discharged from the decomposition furnace and the polymers and the hydrogen chloride before being introduced into the decomposition furnace.

3. The method for manufacturing trichlorosilane according to claim 1, further discharging deposits such as silicon oxide and the like which accumulate on the inner-bottom portion of the decomposition furnace by injecting a pressurized gas into the decomposition furnace.

4. The method for manufacturing trichlorosilane according to claim 1, further breaking silicon oxide which accumulates on the inner-bottom portion of the reaction chamber by rolling a plurality of rolling members which are provided at the inner-bottom portion.

5. The method for manufacturing trichlorosilane according to claim 1, wherein:
providing heaters surrounding the decomposition furnace at a plurality of height positions of the decomposition furnace;
detecting inner temperature at a plurality of height positions of the decomposition furnace and controlling outputs of the heaters in accordance with detecting results of the inner temperature; and
detecting each heater temperature and controlling the outputs of the heaters or supply of raw material in accordance with the heater temperature.

6. The method for manufacturing trichlorosilane according to claim 5, wherein an outer-peripheral surface of the decomposition furnace and an outer-bottom surface of the decomposition furnace are heated by separated heaters.

7. The method for manufacturing trichlorosilane according to claim 5, wherein the heater is made of aluminum bronze.
